(19) United States
(12) Patent Application Publication
(10) Pub. No.: US 2012/0187298 A1
(43) Pub. Date: Jul. 26, 2012

(54) SCINTILLATOR PANEL, METHOD OF MANUFACTURING THE SAME, AND RADIATION DETECTION APPARATUS

(75) Inventors: Yoshito Sasaki, Honjo-shi (JP); Satoshi Okada, Tokyo (JP); Kazumi Nagano, Fujisawa-shi (JP); Keiichi Nomura, Honjo-shi (JP); Yohei Ishida, Honjo-shi (JP); Tomoaki Ichimura, Kitamoto-shi (JP)

(73) Assignee: CANON KABUSHIKI KAISHA, Tokyo (JP)

(21) Appl. No.: 13/349,041

(22) Filed: Jan. 12, 2012

(30) Foreign Application Priority Data
Jan. 26, 2011 (JP) 2011-014382

(51) Int. Cl. G01T 1/202; G01T 1/20

(52) U.S. Cl. 250/361 R; 250/483.1; 427/157

(57) ABSTRACT

A scintillator includes a scintillator layer having a first surface and second surface which are surfaces opposite to each other, wherein the scintillator layer includes a plurality of columnar portions, each columnar portion including a columnar crystal for converting a radiation into light, and the columnar crystal of each columnar portion having a diameter which increases from an intermediate portion between the first surface and the second surface toward the first surface and the second surface.

### BACKGROUND OF THE INVENTION

1. Field of the Invention

The present invention relates to a scintillator panel, method of manufacturing the same, and radiation detection apparatus.

2. Description of the Related Art

Recently, digital radiation detection apparatuses in which scintillator layers for converting a radiation such as an X-ray into light such as visible light are stacked on a sensor panel having a plurality of photoelectric converters have been commercially available. Scintillator materials are mainly an alkali halide-based material typified by a material prepared by doping Tl in CsI, and a material prepared by doping Tb in GdOS. Especially, an alkali halide-based scintillator material typified by CsI can form and grow columnar crystals by a vapor deposition method. The columnar crystal scintillator exhibits a light guiding effect when converting a radiation into visible light, and contributes to sharpness.

Various methods have been tried to control the columnar crystal shape of a scintillator and improve sharpness. For example, Japanese Patent No. 04345460 discloses a method for improving sharpness by gradually increasing the columnar crystal formation rate in vapor deposition to control the columnar crystal shape. Japanese Patent Laid-Open No. 2005-337724 discloses a method of improving sharpness by controlling the partial pressure of an evaporation source in vapor deposition.

To improve the luminance and DQE (Detective Quantum Efficiency) of a scintillator, the scintillator film needs to be made thick. In general, as a scintillator film having columnar crystals becomes thicker, the columnar crystal diameter becomes larger. As a result of increasing the scintillator film thickness, sharpness tends to drop. Even in the methods disclosed in Japanese Patent No. 04345460 and Japanese Patent Laid-Open No. 2005-337724, when the scintillator film is made thick for high scintillator luminance and high DQE, the columnar crystal diameter increases and no satisfactorily sharpness can be expected.

### SUMMARY OF THE INVENTION

The present invention provides a technique advantageous for preventing a decrease in sharpness while increasing the scintillator film thickness.

The first aspect of the present invention provides a scintillator comprising a scintillator layer having a first surface and second surface which are surfaces opposite to each other, wherein the scintillator layer includes a plurality of columnar portions, each columnar portion including a columnar crystal for converting a radiation into light, and the columnar crystal of each columnar portion having a diameter which increases from an intermediate portion between the first surface and the second surface toward the first surface and the second surface.

The second aspect of the present invention provides a radiation detection apparatus comprising: a scintillator defined as the first aspect; and a sensor panel including a photoelectric converter which detects light converted by a scintillator layer of the scintillator.

The third aspect of the present invention provides a method for manufacturing a scintillator, the method comprising: a first growing step of growing a plurality of first columnar crystals on a first substrate to form a first scintillator layer including the plurality of first columnar crystals; a separation step of separating the first substrate from the first scintillator layer; and a second growing step of growing, in a direction opposite to a direction of growing the plurality of first columnar crystals in the first growing step, a plurality of second columnar crystals from portions of the plurality of first columnar crystals, which are exposed after the separation step, thereby forming a second scintillator layer including the plurality of second columnar crystals.

The fourth aspect of the present invention provides a method for manufacturing a scintillator, the method comprising: a growing step of growing columnar crystals from a plurality of protrusive portions of a substrate to form a scintillator layer including the plurality of columnar crystals; and a separation step of separating the substrate from the scintillator layer.

Further features of the present invention will become apparent from the following description of exemplary embodiments with reference to the attached drawings.

### BRIEF DESCRIPTION OF THE DRAWINGS

FIG. 1 is a table schematically showing examples of the structure of a columnar portion in the scintillator layer of a scintillator according to a preferred embodiment of the present invention;

FIG. 2 is a sectional view for explaining the structure of a radiation detection apparatus according to the first embodiment;

FIGS. 3A to 3E are sectional views for explaining a method of manufacturing a scintillator and radiation detection apparatus according to the first embodiment;

FIGS. 4A to 4E are sectional views for explaining a method of manufacturing a scintillator and radiation detection apparatus according to the second and third embodiments;

FIGS. 5A to 5C are sectional views for explaining the structure of a radiation detection apparatus according to the fourth, fifth, and sixth embodiments;

FIGS. 6A to 6C are sectional views for explaining a method of manufacturing a radiation detection apparatus according to the fourth, fifth, and sixth embodiments;

FIGS. 7A to 7E are sectional views for explaining a method of manufacturing a scintillator and radiation detection apparatus according to the seventh embodiment; and

FIG. 8 is a view for explaining a radiation imaging system.

### DESCRIPTION OF THE EMBODIMENTS

Preferred embodiments of the present invention will now be described in detail with reference to the accompanying drawings.

A scintillator according to a preferred embodiment of the present invention includes a scintillator layer having the first and second surfaces which are surfaces opposite to each other. The scintillator may be formed from only the scintillator layer, or may further include another element such as a protection film and/or protection substrate. The scintillator layer includes a plurality of columnar portions, and each columnar portion includes a columnar crystal for converting a radiation into light. The diameter of the columnar crystal increases from an intermediate portion between the first and second surfaces toward the first and second surfaces. The columnar crystal of each columnar portion can have a structure in which the first and second columnar crystals are bonded so that the bonding portion between the first and second columnar crystals is positioned at the intermediate portion. Each columnar portion may have a structure in which the first and second columnar crystals are bonded by an adhesive material, or a structure in which they are directly bonded (that is, without the mediacy of another material or member).

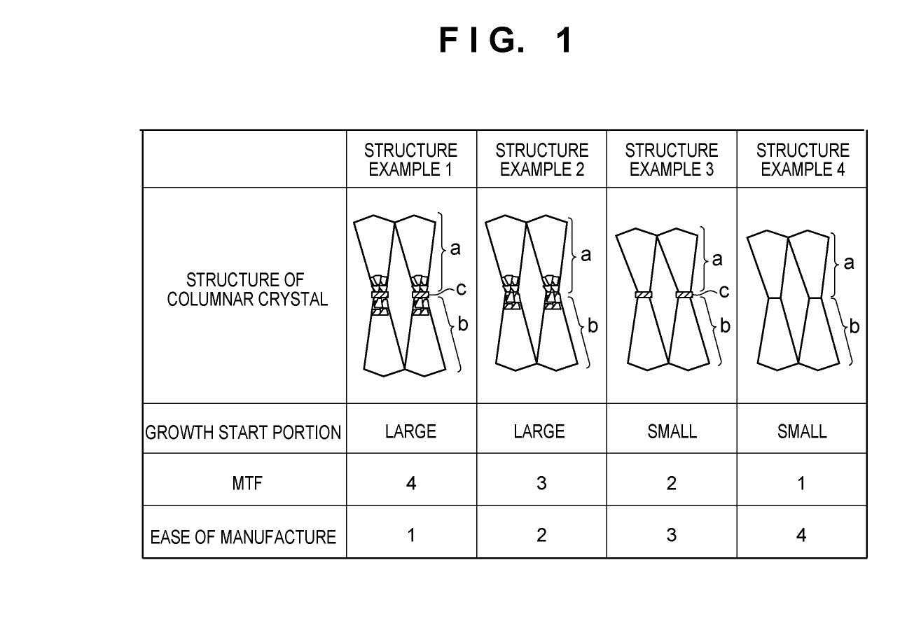

FIG. 1 is a table schematically showing examples of the structure of a columnar portion in the scintillator layer of a scintillator according to a preferred embodiment of the present invention. Each columnar portion forming the scintillator layer includes a columnar crystal for converting a radiation into light (for example, visible light). The columnar crystal can grow on a substrate by a vapor deposition method. In this specification, the vapor deposition method is used as a concept including a chemical vapor deposition method. The columnar crystal has a growth start portion and growth end portion. The average diameter of the columnar crystal at the growth end portion is larger than that of the columnar crystal at the growth start portion. It is considered that when the average diameter of the columnar crystal is large, the light guiding effect becomes poorer than that obtained when the diameter of the columnar crystal is small, thus decreasing sharpness. Referring to FIG. 1, each of columnar portions in structure examples 1 to 4 includes a first columnar crystal a and second columnar crystal b. The upper and lower surfaces of the columnar portion can be regarded as the first and second surfaces, respectively.

The diameters of the columnar crystals a and b increase from an intermediate portion between the first and second surfaces toward the first and second surfaces. The columnar crystal of each columnar portion can have a structure in which the first columnar crystal a and second columnar crystal b are bonded so that the bonding portion between the first columnar crystal a and the second columnar crystal b is positioned at the intermediate portion. The columnar crystal includes the growth start portion in structure examples 1 and 2, and the growth start portion is removed in structure examples 3 and 4. The growth start portion is a portion where crystals vary greatly, and may decrease sharpness because it scatters light propagating through the columnar crystal. Structure examples 3 and 4 are advantageous to sharpness, but require processing for removing the growth start portion. In contrast, structure examples 1 and 2 are disadvantageous to sharpness, but advantageous to easy manufacture.

In structure examples 1 and 3, the first columnar crystal a and second columnar crystal b are bonded by an adhesive material c. In structure examples 2 and 4, the first columnar crystal a and second columnar crystal b are directly bonded. The structure in which the first columnar crystal a and second columnar crystal b are bonded can advantageously decrease the maximum diameter of the columnar crystal. When the total thickness of the first columnar crystal a and second columnar crystal b is formed by one continuous growing process, unlike the present invention, the diameter of the columnar crystal increases in correspondence with the growing process.

As a material for forming a columnar crystal, a material mainly containing an alkali halide is available. Preferable examples are CsI:Tl, CsI:Na, CsBr:Tl, NaI:Tl, LiI:Eu, and KI:Tl. When CsI:Tl is adopted, a columnar crystal can be formed by simultaneously depositing CsI and TlI.

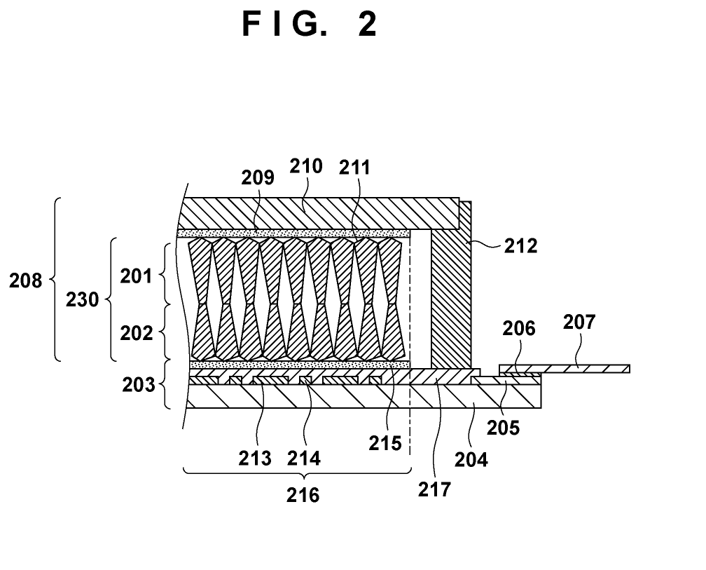

The structure of a radiation detection apparatus according to the first embodiment will be described with reference to FIG. 2. The radiation detection apparatus can include a scintillator (scintillator panel) 208 and sensor panel 203. The scintillator 208 and sensor panel 203 can be adhered by, for example, an adhesion layer 215. The scintillator 208 includes a scintillator layer 230 including a first scintillator layer 201 having a plurality of first columnar crystals and a second scintillator layer 202 having a plurality of second columnar crystals. The scintillator 208 can further include a support substrate 210 which supports the scintillator layer 230. The scintillator layer 230 and support substrate 210 can be adhered by, for example, an adhesion layer 209. The scintillator layer 230 has a structure in which a plurality of columnar portions 211 are arranged. Each columnar portion includes the first and second columnar crystals. A plurality of photoelectric converters 213 are arranged on the sensor panel 203.

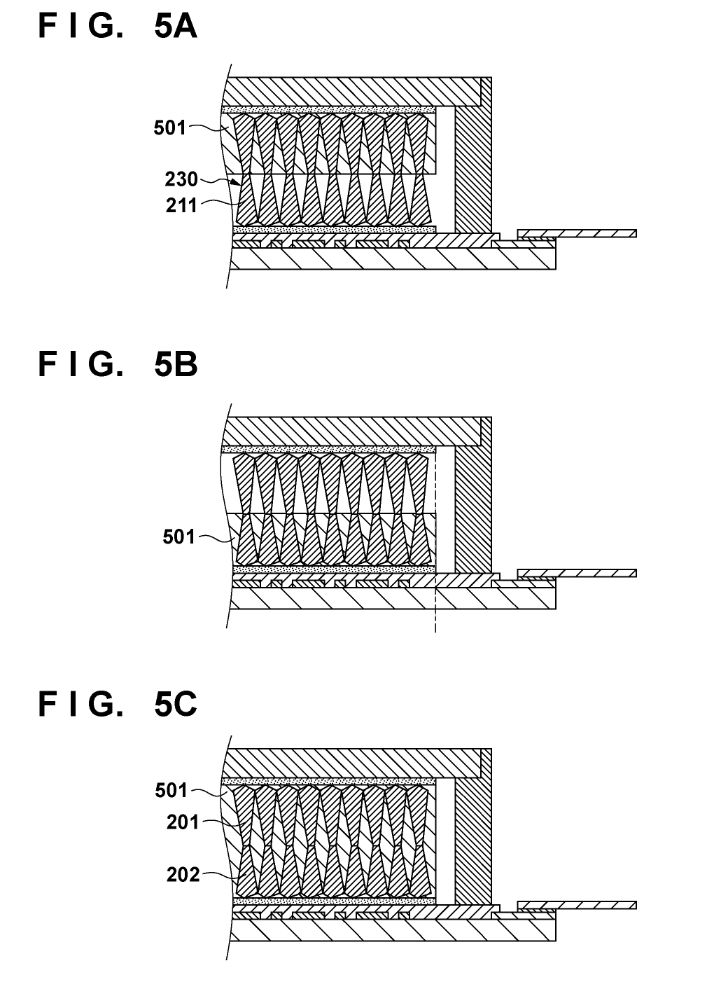

As exemplified in FIGS. 5A to 5C, all or part of the scintillator layer 230 may be covered with a protection layer 501. The protection layer 501 has a moisture-resistant function of preventing moisture from externally entering the scintillator layer 230, and an impact-resistant function of preventing damage to the structure by impact. The thickness of the protection layer 501 is preferably 20 to 200 μm. If the thickness is smaller than 20 μm, the protection layer 501 may not completely cover the surface roughness and splash defect of the scintillator layer 230, and the moisture-resistant function may deteriorate. If the thickness is larger than 200 μm, light generated by the scintillator layer 230 or light reflected by a reflecting layer may scatter much more within the protection layer 501, and the resolution and MTF (Modulation Transfer Function) of an obtained image may decrease.

Examples of the material of the protection layer 501 are general organic sealing materials (for example, a silicone resin, acrylic resin, and epoxy resin), and polyester-, polyolefin-, and polyamide-based hot-melt resins. In particular, a resin having low moisture permeability is desirable. As the protection layer 501, an organic film made of polyparaxylylene, polyurea, polyurethane, or the like is preferably used. A hot-melt resin is also preferably used as long as it can resist a heating process during the manufacture.

The hot-melt resin melts as the resin temperature rises, and hardens as the resin temperature drops. The hot-melt resin exhibits adhesion to other organic and inorganic materials in a heating melting state, and becomes solid and does not exhibit adhesion at room temperature. The hot-melt resin contains none of a polar solvent, solvent, and moisture, and does not dissolve the scintillator layer 230 (for example, a scintillator layer having an alkali halide columnar crystal structure) even if it contacts the scintillator layer. Thus, the hot-melt resin is preferably used for the protection layer 501. The hot-melt resin differs from a solvent evaporation setting adhesive resin prepared by a solvent application method using a thermoplastic resin-dissolved solvent. The hot-melt resin also differs from a chemical reaction adhesive resin prepared by a chemical reaction, typified by an epoxy resin.

Hot-melt resin materials are classified by the type of base polymer (base material) serving as a main component, and polyolefin-, polyester-, and polyamid-based materials and the like are available. For the protection layer 501, high moisture resistance, and high light transparency of transmitting a visible ray generated by a scintillator are important. Hot-melt resins which satisfy moisture resistance requested of the protection layer 501 are preferably a polyolefin-based resin and polyester-based resin. A polyolefin-based resin having low moisture absorptivity is preferably used. As a resin having high light transparency, a polyolefin-based resin is preferable. From this, a polyolefin resin-based hot-melt resin is more preferable for the protection layer 501.

A polyolefin resin preferably mainly contains at least one material selected from an ethylene-vinyl acetate copolymer, ethylene-acrylic acid copolymer, ethylene-acrylic acid ester copolymer, ethylene-methacrylic acid copolymer, ethylene-methacrylic acid ester copolymer, and ionomer resin.

A hot-melt resin mainly containing an ethylene-vinyl acetate copolymer can be Hirodine 7544 (available from Hirodine Kogyo).

A hot-melt resin mainly containing an ethylene-acrylic acid ester copolymer can be O-4121 (available from Kurabo Industries).

A hot-melt resin mainly containing an ethylene-methacrylic acid ester copolymer can be W-4210 (available from Kurabo Industries).

A hot-melt resin mainly containing an ethylene-acrylic acid ester copolymer can be H-2500 (available from Kurabo Industries).

A hot-melt resin mainly containing an ethylene-acrylic acid copolymer can be P-2200 (available from Kurabo Industries).

A hot-melt resin mainly containing an ethylene-acrylic acid ester copolymer can be Z-2 (available from Kurabo Industries).

The support substrate 210 supports the scintillator layer 230, and when a reflecting layer is formed, functions as even the reflecting layer. The reflecting layer has a function of increasing the light use efficiency by reflecting light traveling in a direction opposite to the photoelectric converter 213 out of light converted by the scintillator layer 230 and guiding the light to the photoelectric converter 213. The reflecting layer prevents light (external ray) other than one generated by the scintillator layer 230 from entering the photoelectric converter 213, and prevents noise arising from an external ray from entering the photoelectric converter 213. The support substrate 210 can be, for example, a metal substrate or a substrate having a metal film on the surface of a base material. A thick support substrate 210 has a large radiological dose, and may lead to a large radiation dose by which a subject is exposed. When the support substrate 210 is formed from a metal thin plate, its material is preferably aluminum or the like. When a reflecting layer is formed on a support substrate having no reflecting layer, the support substrate is preferably a carbon- or resin-based substrate which resists heat and hardly absorbs X-rays. The reflecting layer can be made of a metal material such as aluminum, gold, or silver. In particular, aluminum and gold are preferable as high-reflectivity materials.

When a reflecting layer is formed on the support substrate 210, the adhesion layer 209 can preferably use a material which has high transmittance in the emission wavelength region of the scintillator, in order to effectively use light generated from the scintillator layer 230. Further, when a metal reflecting layer is formed on the support substrate 210, a material excellent in corrosion resistance is preferably used. Also, a material excellent in X-ray durability is preferable. A thinner adhesion layer 209 is preferable because sharpness less decreases. However, an excessively thin adhesion layer 209 decreases the adhesion force of the adhesive material itself, and the adhesion layer 209 may peel from the interface between the adhesion layer 209 and the protection layer or that between the adhesion layer 209 and the support substrate. In contrast, when the adhesion layer thickness exceeds 200 μm, the resolution and MTF may drop, similar to the case of the scintillator protection layer.

The sensor panel 203 includes a photoelectric conversion portion (image sensing region) 216 in which the photoelectric converters 213 and TFTs (not shown) are arrayed two-dimensionally on an insulating substrate 204 made of glass or the like. Each signal wiring line 214 is connected to the photoelectric converter 213 or TFT. A connection lead portion 205 is used to connect an external wiring line 207 and the sensor panel 203. The connection lead portion 205 is electrically connected to the external wiring line 207 such as a flexible wiring board via a wiring connection portion 206 such as a solder or anisotropic conductive film (ACF), thereby connecting the sensor panel 203 to an external electric circuit. The sensor panel 203 can include a protection layer 217 made of silicon nitride or the like. The photoelectric converter 213 converts, into charges, light converted from a radiation by the scintillator layer 230. The photoelectric converter 213 can use a material such as amorphous silicon. The structure of the photoelectric converter 213 is not particularly limited, and a MIS sensor, PIN sensor, TFT sensor, or the like is appropriately usable. The signal wiring line 214 is part of a signal wiring line for reading out, via the TFT, a signal photoelectrically converted by the photoelectric converter 213, a bias wiring line for applying a voltage Vs to the photoelectric converter 213, or a driving wiring line for driving the TFT. A signal photoelectrically converted by the photoelectric converter 213 is read out via the TFT, and output to an external signal processing circuit via a peripheral circuit (not shown) and the signal wiring line 214. The gates of TFTs arranged in the row direction are connected to a driving wiring line for each row, and a TFT driving circuit selects a TFT from each row.

Examples of the material of the protection layer 217 are SiN, TiO₂, LiF, Al₂O₃, and MgO. Other examples of the material of the protection layer 217 are a polyphenylene sulfide resin, fluoroplastic, polyether ether ketone resin, and liquid crystal polymer. Still other examples of the material of the protection layer 217 are a polyether nitrile resin, polysulfone resin, polyether sulfone resin, polyallylate resin, polyamide-imide resin, polyetherimide resin, polyimide resin, epoxy resin, and silicone resin. The protection layer desirably has high transmittance at the wavelength of light radiated by the scintillator layer 230 because light converted by the scintillator layer 230 passes through the protection layer upon radiation irradiation. A sealing material 212 which seals the scintillator layer 230 has a moisture-resistant function of preventing moisture from entering the photoelectric conversion portion 216, similar to a scintillator protection layer to be described later. The sealing material 212 is preferably a material having high moisture resistance or a material having low moisture permeability. A preferable example is a resin material such as an epoxy resin or acrylic resin. A silicone-based resin, polyester-based resin, polyolefin-based resin, and polyamide-based resin are also available.

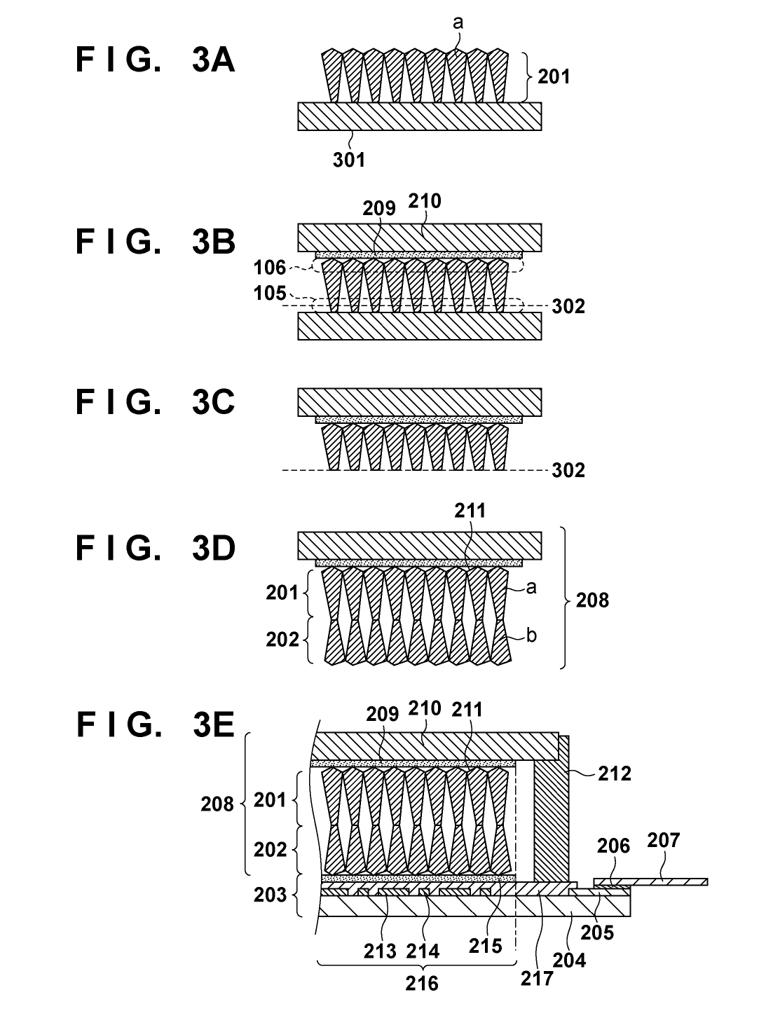

A method of manufacturing a scintillator and radiation detection apparatus according to the first embodiment will be explained with reference to FIGS. 3A to 3E. In the first growing process shown in FIG. 3A, a first scintillator layer 201 including a plurality of first columnar crystals a is formed by growing the first columnar crystals a on a first substrate 301 by a vapor deposition method. For example, when CsI:Tl is formed, the first scintillator layer 201 is formed by simultaneously depositing CsI (cesium iodide) and TlI (thallium iodide). For example, a resistance heating boat is filled with CsI and TlI serving as vapor deposition materials, and the first substrate 301 is set on a support holder. The interior of a vapor deposition apparatus is evacuated, Ar gas is introduced, the degree of vacuum is adjusted to 0.1 Pa, and then vapor deposition is performed.

In a support process shown in FIG. 3B, a side of the first scintillator layer 201 that is opposite to a growth start portion 105, that is, a side of a growth end portion 106 is adhered to a 0.3-mm thick support substrate (Al substrate) 210 via a 20-μm thick heat-resistant adhesion layer 209 such as an acrylic adhesion layer. In a separation process shown in FIG. 3C, the first substrate 301 is separated from the first scintillator layer 201. In the separation process, the first substrate 301 can be removed from the first scintillator layer 201. A structure obtained by executing the second growing process shown in FIG. 3D after removal corresponds to structure example 1 or 2 shown in FIG. 1. Alternatively, in the separation process, the first scintillator layer 201 (first columnar crystal a) may be cut on a cutting plane 302 so that the first scintillator layer 201 (first columnar crystal a) is removed by a portion of a predetermined thickness (to be referred to as a target removal portion) on the side of the first substrate 301, that is, the side of the growth start portion 105. This cutting can be achieved by, for example, laser cutting. When the cutting plane 302 is observed with a scanning electron microscope (SEM), a state in which the section of a columnar crystal appears can be confirmed. A structure obtained by executing the second growing process shown in FIG. 3D after cutting corresponds to structure example 3 or 4 shown in FIG. 1. The thickness of the target removal portion can be arbitrarily determined based on the growth conditions of the first scintillator layer 201 or specifications requested of the scintillator or radiation detection apparatus.

In the second growing process shown in FIG. 3D, a second scintillator layer 202 including a plurality of second columnar crystals b is formed by growing, in a direction opposite to that in the first growing process, the second columnar crystals b from the first columnar crystals a exposed after the separation process shown in FIG. 3C. The formation method and material of the second scintillator layer 202 can be identical to those of the first scintillator layer 201. The second columnar crystal b forming the second scintillator layer 202 can grow while inheriting the shape of the first columnar crystal a forming the first scintillator layer 201. As a result, the first columnar crystal a of the first scintillator layer 201 and the second columnar crystal b of the second scintillator layer 202 can finally form a continuous columnar crystal. By these processes, a scintillator 208 is obtained. This scintillator can also be called a scintillator panel or scintillator plate.

In an assembly process shown in FIG. 3E, the scintillator 208 is adhered to a sensor panel 203 (which can also be called a “photosensor” or “photoelectric conversion panel”) using an acrylic resin-based adhesion layer 215. The sensor panel 203 can be fabricated by forming amorphous silicon (a-Si) on an insulating substrate 204, and forming a plurality of photoelectric converters 213 including photosensors and TFTs (Thin Film Transistors) using the amorphous silicon. Bubbles generated in adhesion can be removed by defoaming processing. The defoaming processing can be pressurization/heating defoaming processing. After that, the end portion is sealed using a sealing material 212 such as an epoxy-based sealing material. The terminal of an external wiring line 207 is thermally contact-bonded via a wiring connection portion 206 onto a connection lead portion 205 on the sensor panel 203. As a consequence, a radiation detection apparatus is obtained.

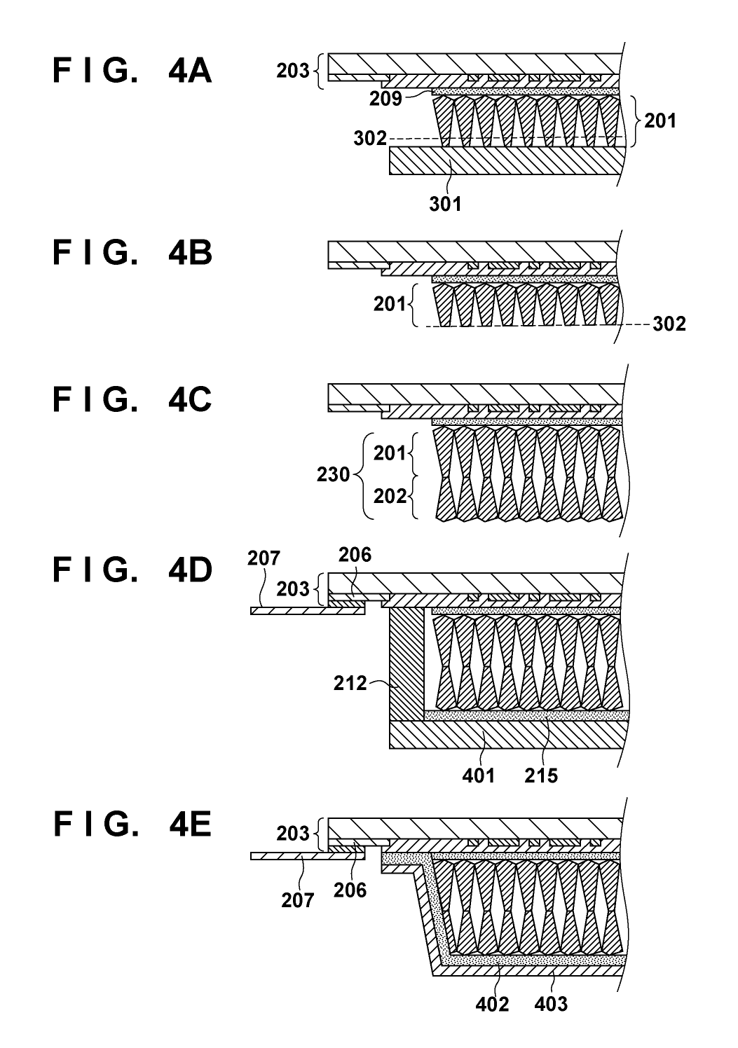

A method of manufacturing a scintillator and radiation detection apparatus according to the second embodiment will be explained with reference to FIGS. 4A to 4E. Note that matters not mentioned in the second embodiment can comply with those in the first embodiment. In the second embodiment, a first scintillator layer 201 is formed in the first growing process shown in FIG. 3A. In a support process shown in FIG. 4A, a sensor panel 203 is used as a substrate which supports the first scintillator layer 201, instead of the support substrate 210 in the first embodiment. After that, a separation process and second growing process shown in FIGS. 4B and 4C are executed similarly to the separation process and second growing process shown in FIGS. 3B and 3C in the first embodiment.

In an assembly process shown in FIG. 4D, an aluminum substrate 401 having a reflecting layer is adhered via an adhesion layer 215 to a scintillator layer 230 including the first scintillator layer 201 and a second scintillator layer 202. Subsequent processing is the same as that in the first embodiment.

A method of manufacturing a scintillator and radiation detection apparatus according to the third embodiment will be explained with reference to FIGS. 4A to 4E again. The third embodiment is the same as the second embodiment up to the second growing process shown in FIG. 4C. After the second growing process, in an assembly process shown in FIG. 4E, a film sheet having an Al film formed as a reflecting layer 403 on a reflecting layer protection layer made of PET is prepared. Then, a scintillator protection layer 402 made of a hot-melt resin containing a polyolefin resin is transferred and bonded to the reflecting layer formation surface of the film sheet using a heating roller. As a result, a three-layered sheet is formed. The sheet is then arranged to cover the scintillator layer 230. The heating roller heats and presses the sheet to fix the sheet to the scintillator layer 230 and sensor panel 203 by welding the scintillator protection layer 402. Subsequent processing is the same as that in the first embodiment.

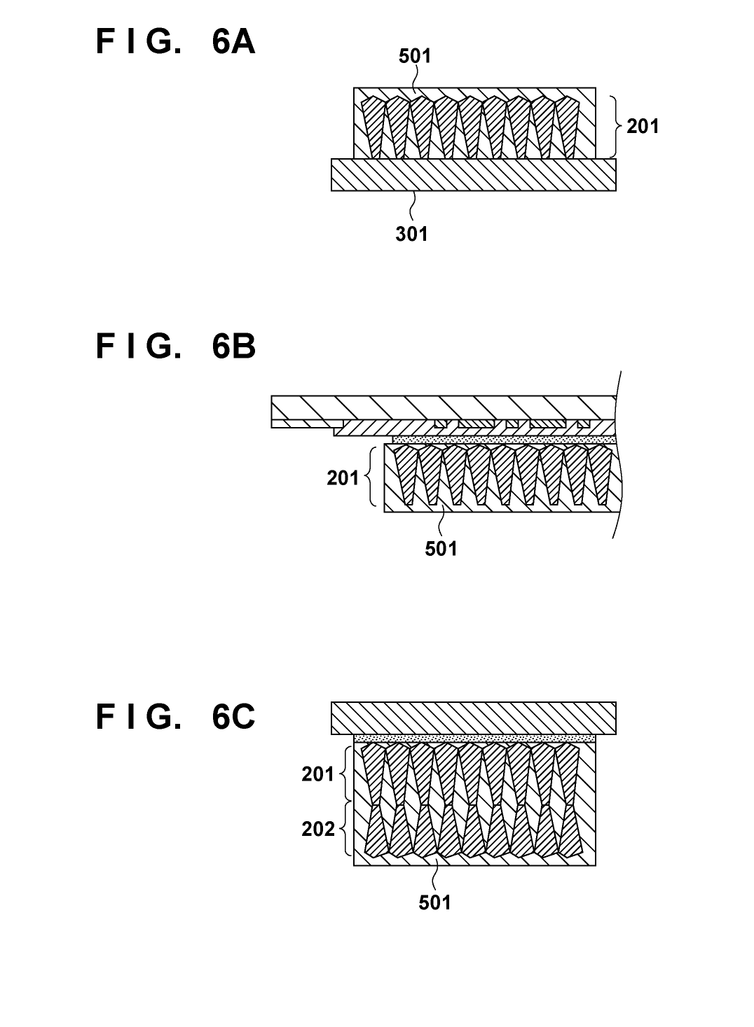

FIG. 5A is a schematic sectional view showing a radiation detection apparatus according to the fourth embodiment. Similar to the first embodiment, a first scintillator layer 201 is deposited on a first substrate 301, as shown in FIG. 3A. Then, a moisture-resistant protection layer (parylene) 501 is stacked on the first scintillator layer 201, as shown in FIG. 6A. The parylene deposition method is not particularly limited and is, for example, vapor phase polymerization. Thereafter, the same processes as those in the first embodiment are performed, obtaining a radiation detection apparatus as shown in FIG. 5A.

FIG. 5B is a schematic sectional view showing a radiation detection apparatus according to the fifth embodiment. After forming a structure up to a state in FIG. 3C similarly to the second embodiment, a moisture-resistant protection layer (parylene) 501 is stacked on a first scintillator layer 201, as shown in FIG. 6B. Then, the same processes as those in the second embodiment are performed, obtaining a radiation detection apparatus as shown in FIG. 5B.

FIG. 5C is a schematic sectional view showing a radiation detection apparatus according to the sixth embodiment. After forming a structure up to a state in FIG. 3D similarly to the first embodiment, a moisture-resistant protection layer (parylene) 501 is stacked on a first scintillator layer 201 and second scintillator layer 202, as shown in FIG. 6C. Then, the same processes as those in the first embodiment are performed, obtaining a radiation detection apparatus as shown in FIG. 5C.

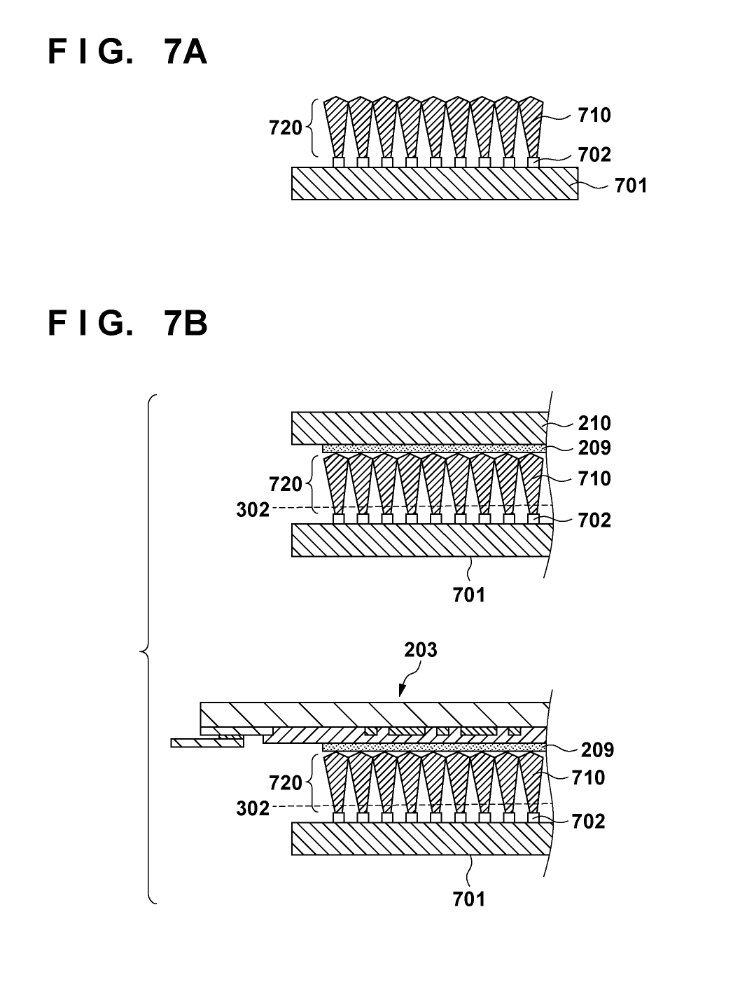

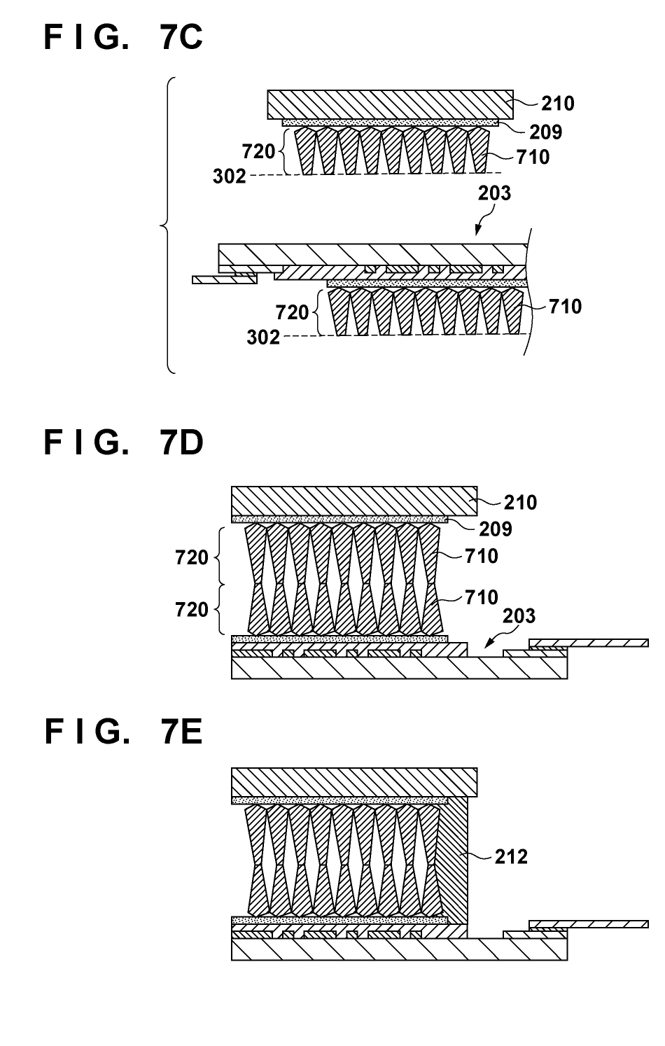

A method of manufacturing a scintillator and radiation detection apparatus according to the seventh embodiment will be explained with reference to FIGS. 7A to 7E. Note that matters not mentioned in the seventh embodiment can comply with those in the first embodiment. In a growing process shown in FIG. 7A, a scintillator layer 720 including a plurality of columnar crystals 710 is formed by growing the columnar crystals 710 from respective protrusive portions 702 of a substrate 701 having the protrusive portions 702. This growing process can be the same as the first growing process shown in FIG. 3A except that the columnar crystals grow on the protrusive portions 702. In this growing process, two scintillator layers 720 are fabricated for one radiation detection apparatus. In a support process shown in FIG. 7B, similar to the support process shown in FIG. 3B, a side of one scintillator layer 720 that is opposite to the growth start portion, that is, a side of the growth end portion is adhered to a support substrate (Al substrate) 210 via an adhesion layer 209. In this support process, similar to the process shown in FIG. 4A, a side of the other scintillator layer 720 that is opposite to the growth start portion, that is, a side of the growth end portion is adhered to a sensor panel 203 via an adhesion layer 209.

In a separation process shown in FIG. 7C, similar to the separation processes shown in FIGS. 3C and 4B, the substrate 701 is separated from the scintillator layer 720 adhered to the support substrate 210. In addition, the substrate 701 is separated from the scintillator layer 720 adhered to the sensor panel 203. At this time, the substrate 701 may be removed from the scintillator layer 720, or the columnar crystals 710 forming the scintillator layer 720 may be cut on a cutting plane 302.

In a bonding process shown in FIG. 7D, the two scintillator layers 720 are bonded so that the columnar crystals 710 of the scintillator layer 720 adhered to the support substrate 210 and the columnar crystals 710 of the scintillator layer 720 adhered to the sensor panel 203 are bonded. At this time, the columnar crystals 710 of the scintillator layer 720 adhered to the support substrate 210 and the columnar crystals 710 of the scintillator layer 720 adhered to the sensor panel 203 may be bonded via an adhesion layer or bonded by pressure contact bonding or the like. The former structure corresponds to structure example 1 or 3 shown in FIG. 1, and the latter corresponds to structure example 2 or 4 shown in FIG. 1. In a sealing process shown in FIG. 7E, the side portion of the scintillator layer 720 is sealed using a sealing material 212.

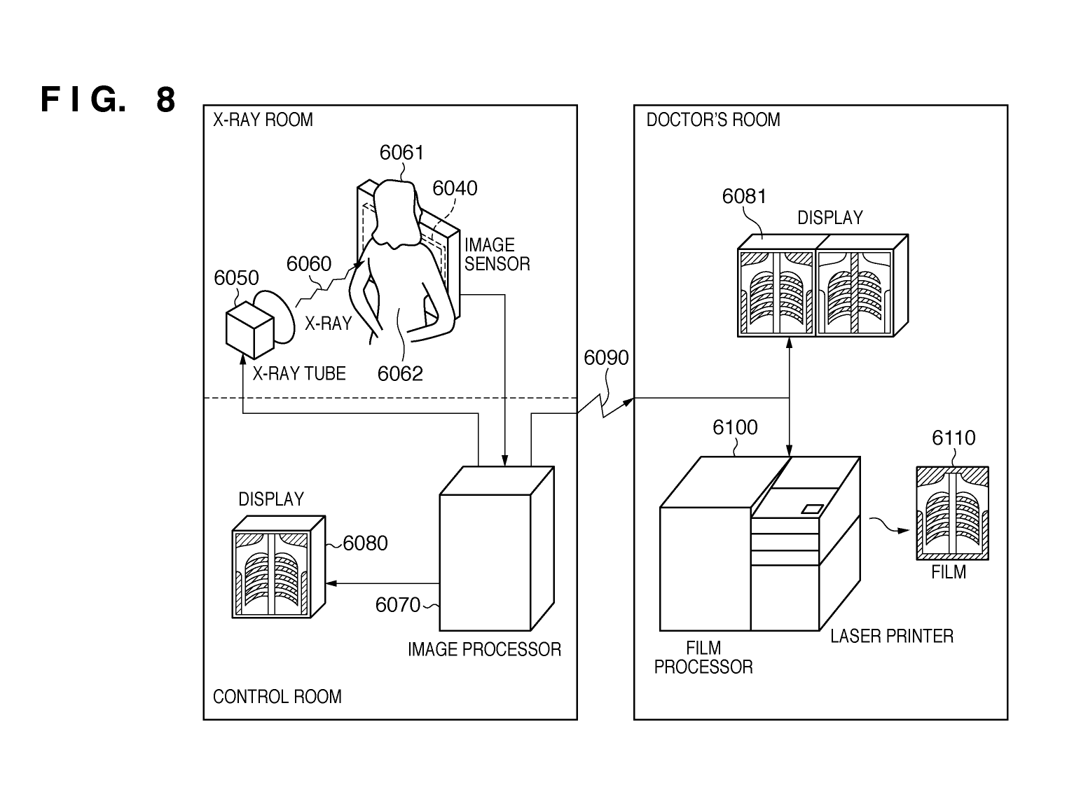

FIG. 8 exemplifies an application of the above-described radiation detection apparatus to a radiation diagnosis system. An X-ray 6060 generated by an X-ray tube 6050 passes through a chest 6062 of a patient or subject 6061, and enters a radiation detection apparatus (image sensor) 6040 as shown in FIG. 8. The entering X-ray contains internal information of the patient or subject 6061. The scintillator (scintillator layer) emits light in correspondence with the entrance of the X-ray, and the photoelectric converters of the sensor panel photoelectrically convert the light, obtaining electrical information. This information is digitally converted, undergoes image processing by an image processor 6070 serving as a signal processing means, and can be observed on a display 6080 serving as a display means in the control room. This information can be transferred to a remote place by a transmission processing means such as a telephone line 6090, and can be displayed on a display 6081 serving as a display means in a doctor room or the like at another place or saved on a recording means such as an optical disk, allowing a doctor at a remote place to make a diagnosis. The information can also be recorded on a film 6110 by a film processor 6100 serving as a recoding means.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-014382, filed Jan. 26, 2011, which is hereby incorporated by reference herein in its entirety.

What is claimed is:

1. A scintillator comprising a scintillator layer having a first surface and second surface which are surfaces opposite to each other, wherein
the scintillator layer includes a plurality of columnar portions, each columnar portion including a columnar crystal for converting a radiation into light, and the columnar crystal of each columnar portion having a diameter which increases from an intermediate portion between the first surface and the second surface toward the first surface and the second surface.

2. The scintillator according to claim 1, wherein each columnar portion has a structure in which the first columnar crystal and the second columnar crystal are bonded and a bonding portion between the first columnar crystal and the second columnar crystal is located at the intermediate portion.

3. The scintillator according to claim 2, wherein each columnar portion has a structure in which the first columnar crystal and the second columnar crystal are bonded by an adhesive material.

4. The scintillator according to claim 2, wherein each columnar portion has a structure in which the first columnar crystal and the second columnar crystal are directly bonded.

5. A radiation detection apparatus comprising:
a scintillator defined in claims 1; and
a sensor panel including a photoelectric converter which detects light converted by a scintillator layer of the scintillator.

6. A method for manufacturing a scintillator, the method comprising:
a first growing step of growing a plurality of first columnar crystals on a first substrate to form a first scintillator layer including the plurality of first columnar crystals;
a separation step of separating the first substrate from the first scintillator layer; and
a second growing step of growing, in a direction opposite to a direction of growing the plurality of first columnar crystals in the first growing step, a plurality of second columnar crystals from portions of the plurality of first columnar crystals, which are exposed after the separation step, thereby forming a second scintillator layer including the plurality of second columnar crystals.

7. The method according to claim 6, wherein in the separation step, the plurality of first columnar crystals are cut to remove the plurality of first columnar crystals by a predetermined thickness on a side of the first substrate.

8. A method for manufacturing a scintillator, the method comprising:
a growing step of growing columnar crystals from a plurality of protrusive portions of a substrate to form a scintillator layer including the plurality of columnar crystals; and
a separation step of separating the substrate from the scintillator layer.

9. The method according to claim 8, wherein further comprising a bonding step of bonding surfaces of two scintillator layers obtained through the growing step and the separation step from which the substrate was separated.
